(19) United States
(12) Patent Application Publication
(10) Pub. No.: US 2026/0326409 A1
(43) Pub. Date: Oct. 22, 2026

(54) AUTOMATIC PAPER CREASING MECHANISM FOR THERMAL PRINTERS

(71) Applicant: Timothy Hren, Mequon, WI (US)

(72) Inventor: Timothy Hren, Mequon, WI (US)

(21) Appl. No.: 19/636,102

(22) Filed: Apr. 1, 2026

Related U.S. Application Data
(60) Provisional application No. 63/789,603, filed on Apr. 16, 2025.

(51) Int. Cl. B31F 1/10; B41J 11/00

(52) U.S. Cl. CPC B31F 1/10; B41J 11/00

(57) ABSTRACT

Technology disclosed herein pertains to paper creasing mechanisms for printers that utilize rolled paper. In one embodiment, a paper creasing device includes a base configured to attach to a printer adjacent to a paper exit path. A first roller mounts to the base and has a groove extending circumferentially around the first roller. A second roller mounts to the base in alignment with the first roller and has a ridge extending circumferentially around the second roller. The ridge engages with the groove of the first roller. A housing supports at least one of the first roller and the second roller. Paper passing between the first roller and the second roller receives a crease from engagement between the ridge and the groove. The crease counteracts the natural curvature of paper stored on cylindrical rolls, allowing the paper to lie flat without additional manual manipulation by personnel.

### CROSS-REFERENCE TO RELATED APPLICATIONS

This application claims priority to U.S. Provisional Application No. 63/789,603 titled SYSTEMS AND METHODS FOR AUTOMATIC CREASING OF THERMAL PAPER, filed Apr. 16, 2025, which is incorporated herein by reference in its entirety for all purposes.

### TECHNICAL FIELD

Aspects of the disclosure are related to the field of printing accessories and paper handling systems and, in particular, to devices and methods for creasing paper as it exits roll-fed printers.

### BACKGROUND

Thermal printers represent a prevalent technology in point-of-sale systems, restaurant order systems, and receipt generation applications across retail, hospitality, and service industries. These printers utilize continuous rolls of thermal paper that pass over a heated print head, creating text and graphics through selective application of heat to chemically treated paper surfaces. The mechanical configuration of these printers involves paper emerging from a cylindrical roll, which results in the paper retaining a pronounced curvature as it exits the printing mechanism. This curvature becomes increasingly pronounced as the diameter of the remaining roll diminishes during use.

The inherent curvature of thermal printer output presents operational challenges in commercial environments where ticket and receipt legibility directly impacts workflow efficiency and customer service quality. Current industry practice involves staff manually flattening each printed ticket through physical manipulation, including creasing, folding, or application of pressure to counteract the natural tendency of the paper to return to its curved state. Alternative approaches include utilizing mechanical devices such as clipboards, ticket rails, or weighted ticket holders to forcibly maintain the paper in a flattened position. These approaches introduce inefficiencies into commercial workflows, requiring additional manipulation time from staff, creating potential for misplaced or illegible tickets, and introducing points of failure into information transmission processes between service departments. Additionally, manual manipulation of thermal paper can accelerate degradation of printed information due to oils transferred from hands, physical wear from repeated handling, and inconsistent application of pressure when attempting to flatten curled tickets.

It is with respect to this general technical environment that aspects of the present technology disclosed herein have been contemplated. Furthermore, although a general environment has been discussed, it should be understood that the examples described herein should not be limited to the general environment identified in the background.

### SUMMARY

Technology disclosed herein relates to paper creasing mechanisms for thermal printers and other roll-fed printing systems. The disclosed technology enables automatic creasing of paper as it exits a printer, counteracting the natural curvature that results from paper being stored on cylindrical rolls. Various implementations include single-piece devices that attach to a printer adjacent to a paper exit path, two-piece systems with components that attach to opposing surfaces of a printer, and printers with built-in creasing mechanisms integrated into the printer body.

The paper creasing mechanisms employ a first roller having a groove extending circumferentially around the roller and a second roller having a ridge extending circumferentially around the roller. The ridge engages with the groove such that paper passing between the two rollers receives a crease from the engagement. The groove and ridge may be V-shaped, with the ridge having a groove angle that is more acute than the groove angle of the groove in some implementations. A housing supports at least one of the rollers and may be hinged to allow adjustment of spacing between the rollers. Tension between the rollers may be adjusted via a set screw or maintained via a spring. The housing may include a grip surface that allows manual displacement of one roller away from the other for paper threading operations or to obtain paper that is not creased.

In two-piece implementations, a first component attaches to a first surface of a printer (such as a stationary base portion) and includes a grooved roller, while a second component attaches to a second surface of the printer (such as a hinged lid portion) and includes a ridged roller. The components are positioned on opposite sides of a paper exit path such that paper exiting the printer passes between the rollers and receives a crease. This configuration allows the printer to be opened normally for paper replacement without removing the creasing system. The components may attach to the printer via adhesive mounting systems, and a spring-loaded housing may maintain pressure between the rollers when the lid is closed.

In printer implementations with built-in creasing mechanisms, the creasing mechanism is positioned along the paper exit path within the printer body. Paper printed by the print head passes between the first roller and the second roller after exiting the print head and before exiting the printer body. The first roller may be coupled to a hinged lid portion of the printer while the second roller is coupled to a stationary base portion, allowing the printer to open for paper loading while maintaining the creasing functionality.

The paper creasing mechanisms disclosed herein provide automatic flattening of thermal paper output, eliminating the need for manual manipulation by personnel and enhancing operational efficiency in commercial environments that utilize receipt and ticket printers. By introducing a counter-crease as paper exits the printer, the mechanisms counteract the natural tendency of rolled paper to curl, resulting in paper that lies flat for improved legibility and handling. The passive operation of the creasing mechanisms utilizes the existing paper feed mechanism without additional power requirements, and the various mounting configurations provide compatibility across multiple printer models without requiring permanent printer modifications.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIGS. 1A-1C illustrate a paper creasing device with an adjustable housing and set screw in an implementation.

FIGS. 2A-2F illustrate a two-piece paper creasing system with separate adjustable and fixed components in an implementation.

FIGS. 3A-3C illustrate a single-piece paper creasing device with a hinged housing in an implementation.

FIGS. 4A-4D illustrate a thermal paper printer with a built-in creasing mechanism in an implementation.

### DETAILED DESCRIPTION

Technology disclosed herein pertains to paper creasing mechanisms that automatically counteract the natural curvature of paper exiting roll-fed printers such as thermal receipt and ticket printers. More specifically, the present technology includes devices and systems that employ complementary rollers—one having a circumferential groove and another having a circumferential ridge—positioned along a paper exit path to create a crease in paper as it exits a printer. The crease counteracts the curl that results from paper being stored on cylindrical rolls, allowing the paper to lie flat without manual manipulation. Various implementations include single-piece devices that attach to a printer adjacent to a paper exit path using adhesive or other mounting systems, two-piece systems with separate components that attach to opposing surfaces of a printer (such as a stationary base portion and a hinged lid portion), and printers with creasing mechanisms built directly into the printer body. The devices may include adjustable housings with set screws or springs to control tension between the rollers, as well as grip surfaces that allow manual displacement of one roller away from the other for paper threading operations or to obtain paper that is not creased. The passive operation of these creasing mechanisms utilizes the existing paper feed mechanism to direct paper through the rollers without additional power requirements, providing compatibility across multiple printer configurations while eliminating the need for staff to manually flatten each printed ticket or receipt.

Thermal printers deployed in commercial environments such as restaurants, retail establishments, and service operations produce output on paper that is stored in cylindrical rolls. As paper feeds from these rolls and passes through the printing mechanism, it retains a pronounced curvature that corresponds to the diameter of the roll from which it was dispensed. This curvature becomes increasingly severe as the roll diameter diminishes during use, with paper from nearly depleted rolls exhibiting tight curling that makes the printed content difficult to read and handle. Personnel working with these printers must manually flatten each ticket or receipt through physical manipulation—creasing, folding, or applying pressure—before the printed information can be effectively used. This manual intervention introduces delays into time-sensitive workflows, particularly in kitchen and service environments where rapid processing of printed orders directly impacts operational throughput.

Current approaches to managing curled thermal paper output rely on workarounds that impose additional burdens on staff and equipment. Clipboards, ticket rails, weighted holders, and similar devices attempt to forcibly maintain paper in a flattened position, but these solutions require additional handling steps and dedicated workspace. Manual manipulation of thermal paper also accelerates degradation of printed content through transfer of oils from hands, physical wear from repeated handling, and inconsistent pressure application. The cumulative effect of these inefficiencies manifests as increased processing time per ticket, potential for misplaced or illegible documents, and points of failure in information transmission between service departments. Existing printer designs do not address the curvature problem at the source, leaving operators to contend with curled output as an inherent characteristic of roll-fed printing systems.

The paper creasing mechanisms disclosed herein address these limitations by introducing a counter-crease to paper as it exits a printer, thereby counteracting the natural curvature at the point of output rather than requiring subsequent manual intervention. A paper creasing device includes a first roller having a groove extending circumferentially around the roller and a second roller having a ridge extending circumferentially around the roller. The ridge engages with the groove such that paper passing between the two rollers receives a crease from the engagement. This crease opposes the curl direction of the paper, causing the paper to lie flat or substantially flat without additional manipulation. The rollers rotate freely on axle pins as paper feeds through the mechanism, utilizing the existing paper feed force from the printer without requiring additional power or motorized components. The passive operation of the creasing mechanism integrates seamlessly with standard printer operation, processing each ticket or receipt automatically as it exits the printer.

The groove and ridge configurations may take various geometric forms depending on the desired crease characteristics. In some implementations, the groove includes a V-shaped profile with angled sides that create a defined crease line, while the ridge includes a corresponding V-shaped profile configured to mate with the groove. The ridge may have a groove angle that is more acute than the groove angle of the groove, which facilitates proper engagement and crease formation. Alternative configurations include U-shaped or rounded profiles that produce a gentler crease, as well as hybrid configurations where the groove and ridge have different profile shapes. The specific geometry selected affects the sharpness and permanence of the resulting crease, allowing the mechanism to be tailored for different paper types, thicknesses, and operational requirements. The thin nature of thermal paper requires minimal pressure to create an effective crease, which simplifies the mechanical requirements of the creasing mechanism.

A housing supports at least one of the rollers in some implementations. The housing is hinged in certain configurations to allow adjustment of spacing between the first roller and the second roller. This adjustability accommodates variations in paper thickness and allows users to calibrate the creasing pressure for optimal results. In some implementations, a set screw provides fixed position adjustment of the spacing between rollers, enabling precise calibration during installation. In other implementations, a spring maintains pressure between the rollers, providing consistent creasing force regardless of paper thickness variations or mechanical wear over time. The spring-loaded configuration automatically compensates for minor variations in paper feed and eliminates the need for periodic recalibration. The housing includes a grip surface in some implementations that allows manual displacement of one roller away from the other, facilitating paper threading operations when loading a new paper roll or enabling retrieval of paper that is not creased when uncreased output is desired. However, adjustability and hinging are not required in all embodiments. Some implementations include a fixed housing configuration with no adjustability, where the rollers maintain a predetermined spacing that accommodates standard thermal paper thicknesses without user intervention.

The paper creasing mechanisms may be implemented in several configurations to accommodate different installation scenarios and printer designs. A single-piece device attaches to a printer adjacent to a paper exit path using an adhesive mounting system or other attachment mechanism. The single-piece device includes a base with a slot configured to receive paper from the printer, the slot having a width sufficient to accommodate thermal paper as it transitions from the printer exit point through the creasing mechanism. Both rollers mount to the base, with one roller supported by a fixed housing and the other supported by an adjustable or hinged housing. This configuration provides a self-contained creasing solution that attaches externally to existing printers without requiring modification to the printer itself.

A two-piece paper creasing system includes a first component configured to attach to a first surface of a printer and a second component configured to attach to a second surface of the printer. The first component includes a grooved roller while the second component includes a ridged roller, with the components positioned on opposite sides of a paper exit path such that paper exiting the printer passes between the rollers and receives a crease. In implementations where the first surface includes a stationary base portion of the printer and the second surface includes a hinged lid portion, the two-piece configuration allows the printer to be opened normally for paper replacement or maintenance without removing the creasing system. Each component attaches independently to its respective printer surface, and the creasing mechanism operates automatically when the lid closes and brings the rollers into engagement. This configuration leverages the existing hinge mechanism of the printer, eliminating the need for a separate hinge assembly within the creasing device itself.

Printers may also incorporate built-in creasing mechanisms integrated directly into the printer body during manufacturing. A printer with a built-in creasing mechanism includes a printer body having a paper exit path, a print head configured to print on paper, and a creasing mechanism positioned along the paper exit path. Paper printed by the print head passes between the first roller and the second roller after exiting the print head and before exiting the printer body, receiving a crease that counteracts the curl from the paper roll. The first roller may be coupled to a hinged lid portion of the printer while the second roller is coupled to a stationary base portion, maintaining the ability to open the printer for paper loading while providing integrated creasing functionality. This manufacturer-integrated approach eliminates the need for aftermarket accessories and allows for optimal positioning and alignment of the creasing components relative to the paper path.

In operation, a method of creasing paper exiting a printer includes receiving paper from a paper exit path of the printer, the paper having a curvature resulting from storage on a cylindrical roll. The method includes passing the paper between a first roller having a groove extending circumferentially around the first roller and a second roller having a ridge extending circumferentially around the second roller. The ridge engages with the groove as the paper passes between the first roller and the second roller, and the paper receives a crease from the engagement between the ridge and the groove. The crease counteracts the curvature of the paper, causing the paper to lie flat or substantially flat. The first roller and the second roller rotate as the paper passes between them, with the rotation driven by paper feed force from the printer without requiring additional power or motorized components.

In some implementations, the method includes adjusting spacing between the first roller and the second roller to accommodate variations in paper thickness or to calibrate creasing pressure. Adjusting the spacing may include rotating a set screw to increase or decrease the distance between the rollers, or may include displacing a spring-loaded housing that automatically returns to a default position. In some implementations, the method includes manually displacing one of the first roller and the second roller away from the other to thread paper through the creasing mechanism or to obtain paper that is not creased. Manually displacing may include pressing on a grip surface of a housing supporting one of the rollers.

Various technical effects may be appreciated from the implementations described herein. The paper creasing mechanisms enable automatic flattening of thermal paper output by introducing a counter-crease at the point of paper exit, eliminating the manual manipulation steps that otherwise interrupt commercial workflows. By positioning complementary grooved and ridged rollers along the paper exit path, the mechanisms leverage the existing paper feed force from the printer to create a crease without requiring additional power sources, motors, or electronic components. This passive operation reduces mechanical complexity while providing consistent crease application across varying paper thicknesses and roll diameters. The automatic creasing functionality decreases per-ticket processing time by removing the manual flattening step, reduces physical handling that accelerates degradation of printed content, and minimizes the potential for misplaced or illegible documents in time-sensitive service environments. The various mounting configurations—including single-piece attachments, two-piece systems, and built-in printer implementations—provide deployment flexibility across diverse printer models without requiring permanent modifications to existing equipment.

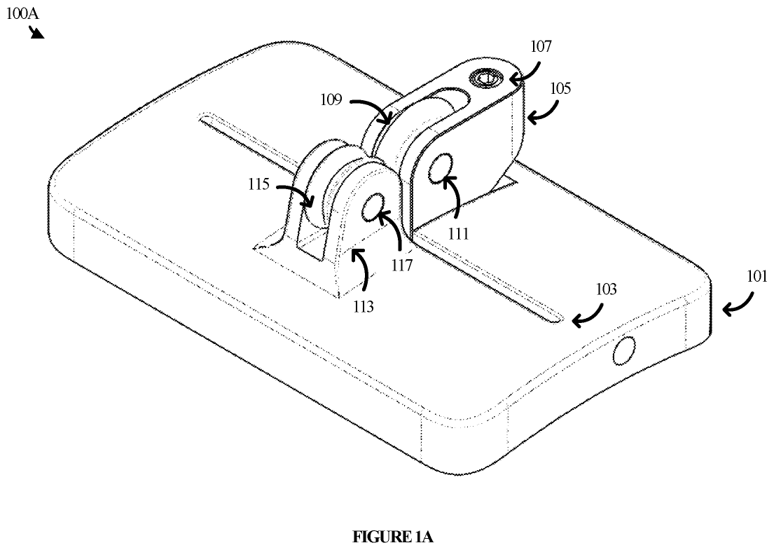

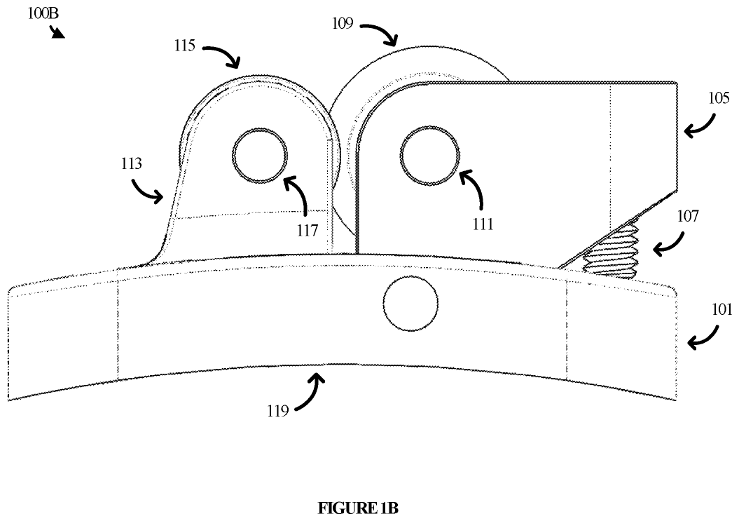

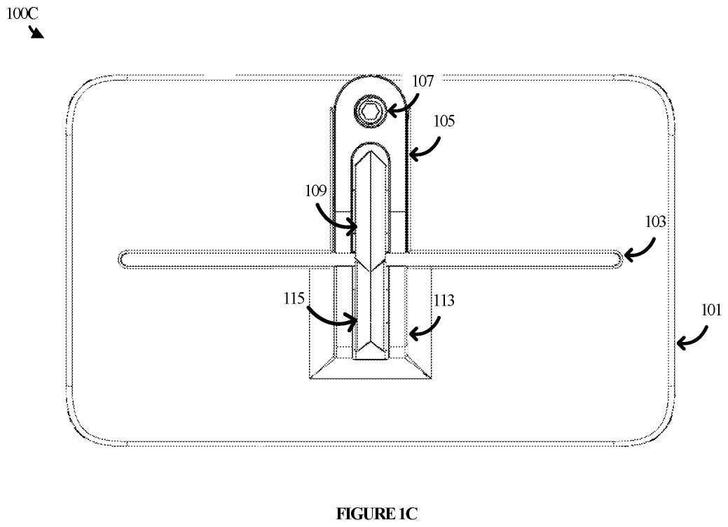

Referring to FIGS. 1A-1C, paper creasing device 101 represents one implementation of a single-piece paper creasing mechanism configured for attachment to a thermal paper printer. FIG. 1A illustrates isometric view 100A of paper creasing device 101, FIG. 1B illustrates side view 100B of paper creasing device 101, and FIG. 1C illustrates top view 100C of paper creasing device 101. Paper creasing device 101 includes a base configured to attach to a printer adjacent to a paper exit path, with the base providing structural support for the creasing components.

As shown in FIG. 1A, paper creasing device 101 includes slot 103 formed within the base. Slot 103 is configured to receive paper from the printer and has a width sufficient to accommodate thermal paper as it transitions from the printer exit point through the creasing mechanism. Slot 103 functions as a paper guide pathway, maintaining alignment of the thermal paper as it passes through paper creasing device 101 to provide consistent crease application across the paper width.

Paper creasing device 101 includes grooved roller 115 mounted to the base. Grooved roller 115 has a groove extending circumferentially around grooved roller 115. Fixed housing 113 supports grooved roller 115 and comprises a roller riser that raises grooved roller 115 up from the base, positioning grooved roller 115 on one side of the paper path. Grooved roller 115 mounts on axle pin 117 that enables free rotation as paper passes through the mechanism. In some implementations, grooved roller 115 is a separate component from axle pin 117, while in other implementations grooved roller 115 is affixed to axle pin 117 or manufactured as one integrated piece with axle pin 117. Grooved roller 115 may include a bearing component where grooved roller 115 surrounds a bearing, or grooved roller 115 may operate without a separate bearing component, or grooved roller 115 may be integrated into the outer race of a bearing.

With continued reference to FIG. 1A, paper creasing device 101 includes ridged roller 109 mounted to the base in alignment with grooved roller 115. Ridged roller 109 has a ridge extending circumferentially around ridged roller 109 and is configured to engage with the groove of grooved roller 115. Adjustable housing 105 supports ridged roller 109 and positions ridged roller 109 opposite grooved roller 115. Ridged roller 109 mounts on axle pin 111 that enables free rotation during paper passage. Similar to grooved roller 115, ridged roller 109 may be a separate component from axle pin 111, affixed to axle pin 111, or manufactured as one integrated piece with axle pin 111. Ridged roller 109 may include a bearing component, operate without a separate bearing component, or be integrated into the outer race of a bearing.

The groove of grooved roller 115 may include a V-shaped groove with angled sides that create a defined crease line. Alternatively, the groove may include more of a U-shaped profile with a rounded bottom, or other groove configurations. The ridge of ridged roller 109 may include a V-shaped ridge configured to mate with the V-shaped groove of grooved roller 115. In some implementations, the V-shaped ridge has a groove angle that is more acute than a groove angle of the V-shaped groove of grooved roller 115, which facilitates proper engagement and crease formation. In other implementations, the groove angle of ridged roller 109 is the same as the groove angle of grooved roller 115. The groove profiles between grooved roller 115 and ridged roller 109 may be mismatched, where one roller has a sharp V-profile and the other has a more rounded profile. Grooved roller 115 and ridged roller 109 may have some small radius on their edges for a less sharp or more rounded crease rather than perfectly sharp angled edges.

As shown in FIG. 1B, adjustable housing 105 is hinged to the base to allow adjustment of spacing between grooved roller 115 and ridged roller 109. This adjustability accommodates variations in paper thickness and allows users to calibrate the creasing pressure. Paper creasing device 101 includes set screw 107 associated with adjustable housing 105. Set screw 107 is configured to adjust tension between grooved roller 115 and ridged roller 109, enabling precise calibration of the creasing force during installation and operation. Set screw 107 threads into adjustable housing 105 and extends toward the base or a fixed portion of paper creasing device 101. Rotating set screw 107 in one direction advances the screw tip and pushes adjustable housing 105 away from the base, increasing the spacing between grooved roller 115 and ridged roller 109 and reducing creasing pressure. Rotating set screw 107 in the opposite direction retracts the screw tip and allows adjustable housing 105 to move closer to the base, decreasing the spacing between the rollers and increasing creasing pressure. This threaded adjustment mechanism provides fine control over roller engagement depth, allowing operators to optimize crease formation for different paper weights and curl severities. Grooved roller 115 and ridged roller 109 contact each other during operation in some configurations, while grooved roller 115 and ridged roller 109 maintain a small space between them in other configurations depending on the tension adjustment provided by set screw 107.

When paper passes through slot 103 and between ridged roller 109 and grooved roller 115, the paper receives a crease from engagement between the ridge and the groove. The engagement between the ridge of ridged roller 109 and the groove of grooved roller 115 creates a crease in the paper that counteracts the natural curvature resulting from storage on cylindrical rolls. The rollers rotate freely on their respective axle pins as paper feeds through the mechanism, utilizing the existing paper feed force from the printer.

As further shown in FIG. 1B, paper creasing device 101 includes mounting surface 119 positioned along the bottom portion of the base. Mounting surface 119 is configured to attach paper creasing device 101 to a printer adjacent to a paper exit path. The base is configured to attach to the printer via an adhesive mounting system in some implementations, such as industrial-grade double-sided tape with adequate tensile and shear strength characteristics. Mounting surface 119 may be flat or contoured to match the surface contours of the printer to which paper creasing device 101 attaches.

Alternative attachment mechanisms include magnetic mounting systems utilizing magnets embedded in the base with corresponding ferrous plates on the printer housing. Paper creasing device 101 may attach to the printer via mechanical fasteners such as screws or pins. Hybrid attachment systems combining adhesive mounting with magnetic elements provide stability while preserving repositioning capabilities. Paper creasing device 101 may include adjustable mounting brackets with spring-loaded tension mechanisms that secure paper creasing device 101 through mechanical pressure against printer housing surfaces.

Paper creasing device 101 may be constructed from plastic, polycarbonate, aluminum, composite materials, or the like, with specific materials selected based on durability requirements, friction characteristics, and manufacturing considerations. Paper creasing device 101 may be manufactured using injection molding for high-volume production, CNC machining for limited production runs, additive manufacturing, or other manufacturing methods for prototyping and custom applications.

The embodiment of paper creasing device 101 illustrated in FIGS. 1A-1C represents one example implementation, and other implementations exist without deviating from the scope of the disclosure. Other implementations may include devices with additional, fewer, or different elements in different configurations. For example, some implementations may omit adjustable housing 105 in favor of a fixed housing configuration, may omit set screw 107 in favor of spring-loaded tension, may omit axle pins 111 and 117 in favor of alternative roller mounting arrangements, or may include or omit bearing components depending on operational requirements. The components themselves may differ across implementations, including variations in adjustability, axle configurations, bearing arrangements, groove and ridge geometries, and attachment mechanisms.

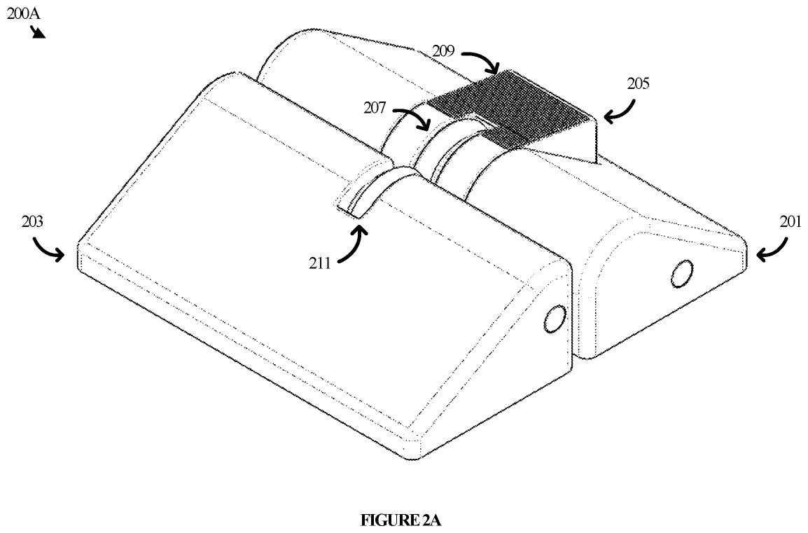

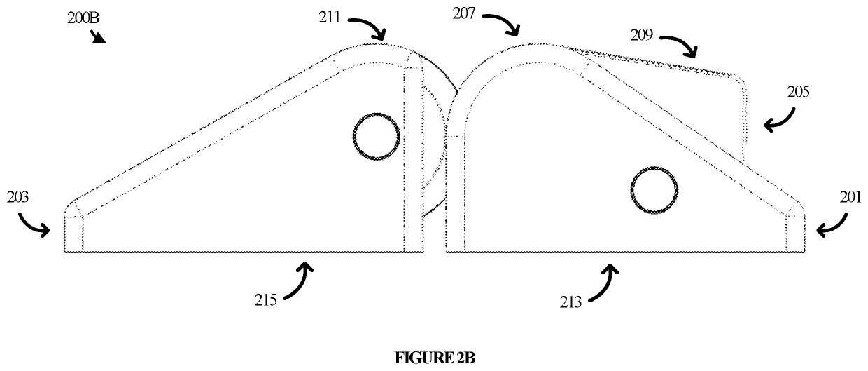

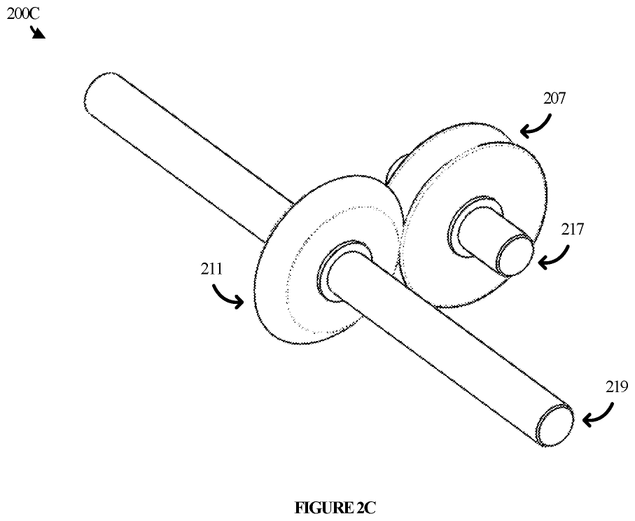

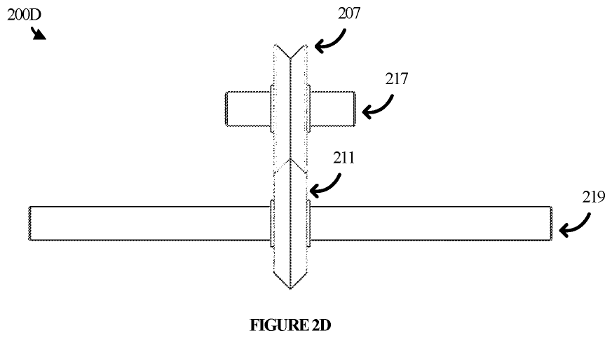

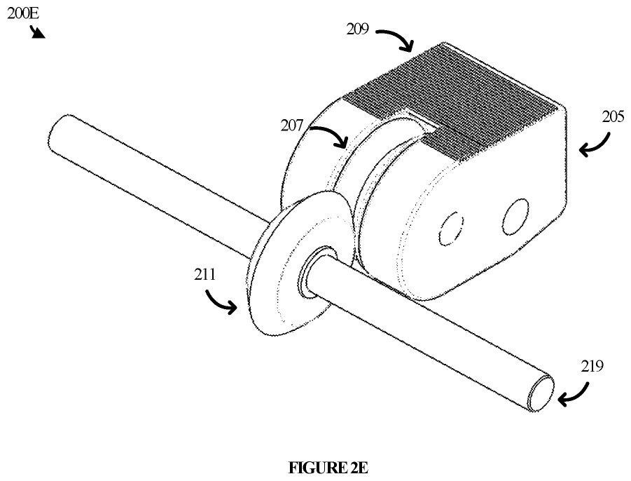

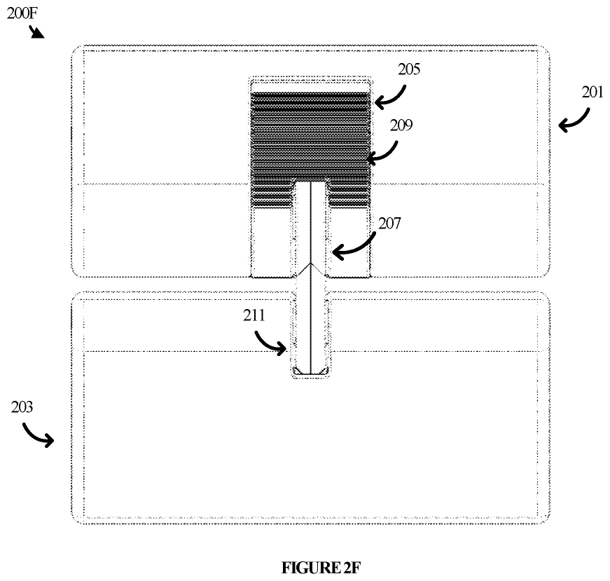

Referring to FIGS. 2A-2F, a two-piece paper creasing system represents an alternative implementation configured for attachment to a thermal paper printer. FIG. 2A illustrates isometric view 200A of the two-piece paper creasing system, FIG. 2B illustrates side view 200B, FIG. 2C illustrates isometric view 200C of the roller components, FIG. 2D illustrates top view 200D of the roller components, FIG. 2E illustrates isometric view 200E of some components, and FIG. 2F illustrates top view 200F of the two-piece paper creasing system. The two-piece paper creasing system includes adjustable component 201 and fixed component 203 as two separate pieces that attach independently to opposing surfaces of a printer.

As shown in FIG. 2A, adjustable component 201 is configured to attach to a first surface of a printer, while fixed component 203 is configured to attach to a second surface of the printer. Adjustable component 201 and fixed component 203 are configured to be positioned on opposite sides of a paper exit path of the printer such that paper exiting the printer passes between the rollers of the two components and receives a crease. In some implementations, the first surface includes a hinged lid portion of the printer and the second surface includes a stationary base portion of the printer. In other implementations, the first surface includes a stationary base portion and the second surface includes a hinged lid portion. This two-piece configuration allows the printer to be opened normally for paper replacement or maintenance without removing the creasing system, as each component attaches separately to its respective printer surface.

With continued reference to FIG. 2A, adjustable component 201 includes hinged housing 205 that supports grooved roller 207. Grooved roller 207 has a groove extending circumferentially around grooved roller 207. Hinged housing 205 includes grip surface 209 positioned on an upper portion of hinged housing 205. Grip surface 209 provides a textured area configured to allow manual displacement of grooved roller 207 away from ridged roller 211 for paper threading operations, such as when loading a new paper roll, or to obtain paper that is not creased when uncreased output is desired.

Fixed component 203 includes ridged roller 211 that has a ridge extending circumferentially around ridged roller 211. Ridged roller 211 is configured to engage with grooved roller 207 when adjustable component 201 and fixed component 203 are positioned on opposite sides of a paper exit path of a printer. Paper exiting the printer passes between grooved roller 207 and ridged roller 211 and receives a crease from engagement between the ridge and the groove. The groove of grooved roller 207 may include a V-shaped groove, and the ridge of ridged roller 211 may include a V-shaped ridge configured to mate with the V-shaped groove. Alternative groove and ridge configurations include U-shaped profiles, rounded profiles, or mismatched profiles as described previously with respect to paper creasing device 101.

As shown in FIG. 2B, side view 200B depicts the spatial relationship between adjustable component 201 and fixed component 203 when positioned for operation. Fixed component 203 includes mounting surface 215 on a lower portion of fixed component 203, and adjustable component 201 includes mounting surface 213 on a lower portion of adjustable component 201. Mounting surface 213 and mounting surface 215 are configured to attach to respective surfaces of a printer. Adjustable component 201 and fixed component 203 are each configured to attach to the printer via an adhesive mounting system, such as industrial-grade double-sided tape. Alternative attachment mechanisms include magnetic mounting systems, mechanical fasteners, or hybrid attachment systems as described previously.

Referring to FIGS. 2C and 2D, the roller components of the two-piece paper creasing system are shown in isolation. Grooved roller 207 mounts on axle pin 217 that allows grooved roller 207 to rotate freely as paper passes through the creasing mechanism. Ridged roller 211 mounts on axle pin 219 that enables rotation of ridged roller 211 during paper passage. As shown in top view 200D, axle pin 217 and axle pin 219 are oriented parallel to each other, ensuring proper alignment between the two rollers for consistent crease application across the width of the paper.

With reference to FIG. 2E, isometric view 200E shows hinged housing 205 supporting grooved roller 207, along with ridged roller 211 and axle pin 219. Hinged housing 205 may be spring-loaded to maintain pressure between grooved roller 207 and ridged roller 211. The spring-loaded configuration maintains consistent creasing pressure regardless of paper thickness variations or mechanical wear over time, eliminating the need for manual adjustment via a set screw. When a user presses on grip surface 209, hinged housing 205 displaces grooved roller 207 away from ridged roller 211. Upon release, the spring returns hinged housing 205 to its default position for creasing.

As shown in top view 200F of FIG. 2F, adjustable component 201 and fixed component 203 are positioned with grooved roller 207 and ridged roller 211 in alignment. The distance between grooved roller 207 and ridged roller 211 may vary depending on the implementation. In some configurations, grooved roller 207 and ridged roller 211 contact each other during operation, while in other configurations a small space exists between the rollers that is sufficient to crease the paper at the desired intensity.

The configuration shown in FIGS. 2A-2F positions ridged roller 211 on fixed component 203 and grooved roller 207 on adjustable component 201 with hinged housing 205. However, alternative configurations position ridged roller 211 on the hinged housing side with grooved roller 207 on the fixed housing side. The rollers may be arranged on either component without departing from the scope of the disclosure.

The two-piece paper creasing system may be accompanied by an installation guide that specifies a recommended distance for mounting adjustable component 201 and fixed component 203 apart from each other. The gap between adjustable component 201 and fixed component 203 is at least wide enough for receipt paper thickness to pass through. The installation guide provides users with spacing recommendations to ensure proper alignment and crease formation for different printer models and paper widths.

The embodiment of the two-piece paper creasing system illustrated in FIGS. 2A-2F represents one example implementation, and other implementations exist without deviating from the scope of the disclosure. Other implementations may include systems with additional, fewer, or different elements in different configurations. The components themselves may differ across implementations, including variations in adjustability (such as fixed housings without hinging), axle configurations (such as integrated axles or alternative mounting arrangements), bearing arrangements (such as separate bearing components, no bearing components, or rollers integrated into bearing outer races), groove and ridge geometries, and attachment mechanisms.

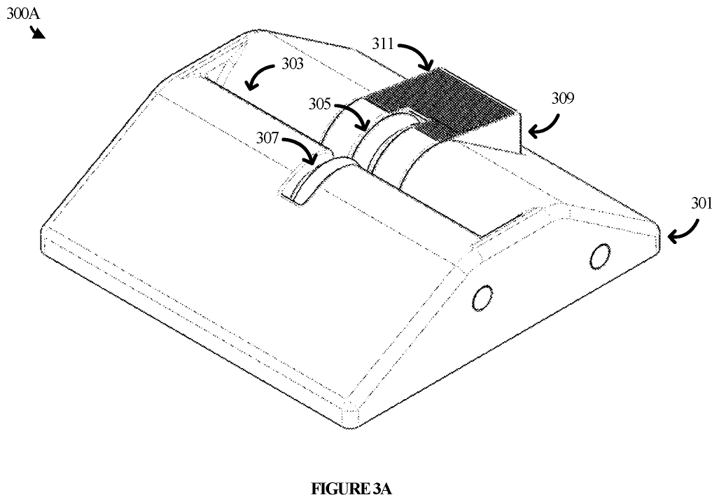

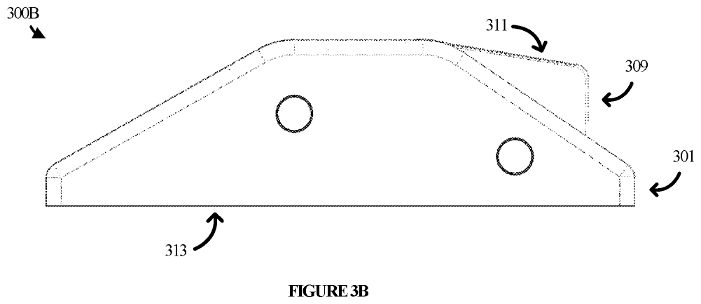

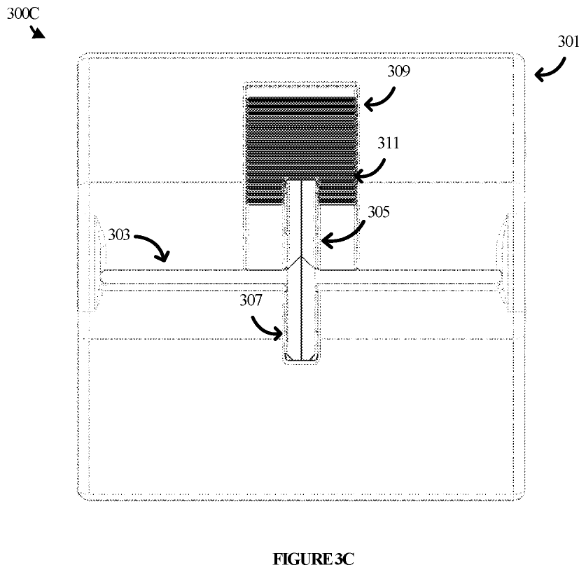

Referring to FIGS. 3A-3C, paper creasing device 301 represents another implementation of a single-piece paper creasing mechanism configured for attachment to a thermal paper printer. FIG. 3A illustrates isometric view 300A of paper creasing device 301, FIG. 3B illustrates side view 300B of paper creasing device 301, and FIG. 3C illustrates top view 300C of paper creasing device 301. Paper creasing device 301 includes a base configured to attach to a printer adjacent to a paper exit path, with the base providing structural support for the creasing components in a unified housing.

As shown in FIG. 3A, paper creasing device 301 includes slot 303 formed within the base. Slot 303 is configured to receive paper from the printer and has a width sufficient to accommodate thermal paper as it transitions from the printer exit point through the creasing mechanism. Slot 303 may incorporate an adjustable width mechanism utilizing laterally adjustable guides with fixed stop positions corresponding to standard paper widths such as 58 mm, 80 mm, and 112 mm. The adjustable guides allow paper creasing device 301 to accommodate different paper widths used across various printer models and applications.

Paper creasing device 301 includes grooved roller 305 mounted to the base. Grooved roller 305 has a groove extending circumferentially around grooved roller 305. The groove of grooved roller 305 may include a V-shaped groove with angled sides that create a defined crease line. Hinged housing 309 supports grooved roller 305 and positions grooved roller 305 on one side of the paper path within paper creasing device 301.

With continued reference to FIG. 3A, paper creasing device 301 includes ridged roller 307 mounted to the base in alignment with grooved roller 305. Ridged roller 307 has a ridge extending circumferentially around ridged roller 307 and is configured to engage with the groove of grooved roller 305. The ridge of ridged roller 307 may include a V-shaped ridge configured to mate with the V-shaped groove of grooved roller 305. In some implementations, the V-shaped ridge has a groove angle that is more acute than a groove angle of the V-shaped groove of grooved roller 305, which facilitates proper engagement and crease formation. When paper passes between grooved roller 305 and ridged roller 307, the paper receives a crease from engagement between the ridge and the groove.

Hinged housing 309 includes grip surface 311 positioned on an upper portion of hinged housing 309. Grip surface 311 is configured to allow manual displacement of grooved roller 305 away from ridged roller 307. A user presses on grip surface 311 to move hinged housing 309 and displace grooved roller 305, enabling paper threading operations when loading a new paper roll or enabling retrieval of paper that is not creased when uncreased output is desired. Grip surface 311 provides thumb or finger traction for pressing and manipulating hinged housing 309 during operation.

Hinged housing 309 may be spring-loaded to maintain pressure between grooved roller 305 and ridged roller 307. The spring-loaded configuration maintains consistent creasing pressure regardless of paper thickness variations or mechanical wear over time, eliminating the need for manual adjustment via a set screw. When a user releases grip surface 311 after pressing, the spring automatically returns hinged housing 309 to its default position where grooved roller 305 engages with ridged roller 307 for creasing.

As shown in FIG. 3B, side view 300B depicts the profile of paper creasing device 301. Paper creasing device 301 includes mounting surface 313 positioned along the bottom portion of the base. Mounting surface 313 is configured to attach paper creasing device 301 to a printer adjacent to a paper exit path. The base is configured to attach to the printer via an adhesive mounting system, such as industrial-grade double-sided tape with adequate tensile and shear strength characteristics. Mounting surface 313 may be flat or contoured to match the surface contours of the printer to which paper creasing device 301 attaches, accommodating various printer surface configurations and designs.

Paper creasing device 301 may include a quick-release design featuring snap-fit components or a hinged release mechanism that allows for rapid removal of paper creasing device 301 for maintenance or paper jam clearing without disturbing the primary mounting adhesive. The quick-release design may incorporate spring-loaded retention clips that maintain proper positioning while allowing tool-free removal when needed.

In some implementations, paper creasing device 301 attaches to a printer via a two-part mounting system that includes a permanent base plate secured to the printer housing through industrial-grade adhesive tape or mechanical fasteners, combined with a detachable upper assembly that clips onto the base plate. The base plate remains affixed to the printer surface adjacent to the paper exit path while the upper assembly containing the creasing rollers detaches for cleaning or jam removal. Alternative attachment configurations include magnetic mounting systems that utilize embedded magnets in the device base paired with ferrous mounting plates adhered to the printer, enabling repositioning without adhesive replacement. Some implementations employ bracket-style mounts with adjustable tension arms that grip the printer housing edges, providing secure attachment without permanent adhesive while accommodating printers with varying housing geometries.

Paper creasing device 301 may include an integrated paper cutting edge positioned after the creasing mechanism for clean separation of individual receipts or tickets while maintaining the flattened condition of the paper. In implementations where paper creasing device 301 includes slot 303 that receives paper from the printer, the cutting edge of paper creasing device 301 serves as the primary tearing point rather than the printer's built-in cutting edge, since the paper passes through slot 303 and the creasing mechanism before reaching the cutting edge on the far side of paper creasing device 301.

In some embodiments, low-friction coatings such as PTFE or silicone-based materials may be applied to contact surfaces of grooved roller 305 and ridged roller 307 to reduce drag on paper as it passes through the creasing mechanism. The low-friction coatings minimize resistance during paper passage while maintaining effective crease formation.

In an alternative embodiment, paper creasing device 301 may incorporate a multi-point creasing system instead of the single groove and ridge roller configuration described above. The multi-point creasing system utilizes 2-3 smaller diameter rollers of approximately 3-6 mm positioned at alternating offset angles to create a gentle zigzag pattern in the paper. This configuration produces multiple micro-creases rather than a single dominant crease line, providing more thorough flattening that may be particularly suitable for tightly curled paper from nearly depleted rolls. The multi-point creasing approach may be implemented in any of the device configurations disclosed herein, including single-piece devices such as paper creasing device 101 and paper creasing device 301, two-piece systems such as the system comprising adjustable component 201 and fixed component 203, and printers with built-in creasing mechanisms such as the thermal paper printer comprising printer body 401. In such implementations, the multi-point roller arrangement replaces the grooved roller and ridged roller pair while maintaining the same housing configurations, mounting systems, and adjustability features described for each respective embodiment.

The embodiment of paper creasing device 301 illustrated in FIGS. 3A-3C represents one example implementation, and other implementations exist without deviating from the scope of the disclosure. Other implementations may include devices with additional, fewer, or different elements in different configurations. For example, some implementations may include adjustable housings with set screws rather than spring-loaded hinged housings, may include or omit axle pins depending on roller mounting arrangements, may include or omit bearing components depending on operational requirements, or may position grooved roller 305 and ridged roller 307 on opposite sides from the configuration shown. The components themselves may differ across implementations, including variations in adjustability, axle configurations, bearing arrangements, groove and ridge geometries, attachment mechanisms, and the presence or absence of quick-release features, cutting edges, or low-friction coatings.

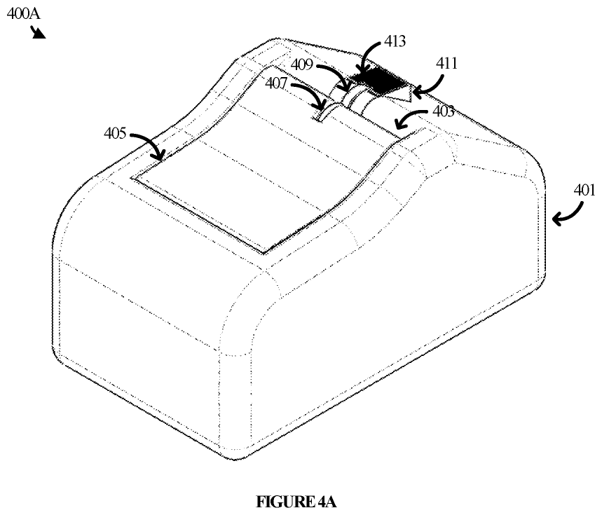

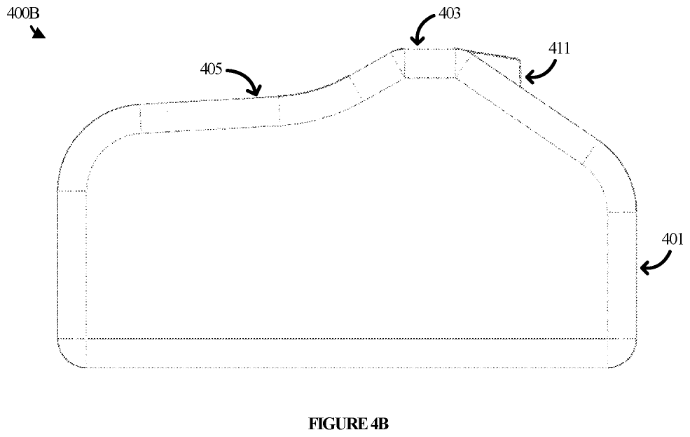

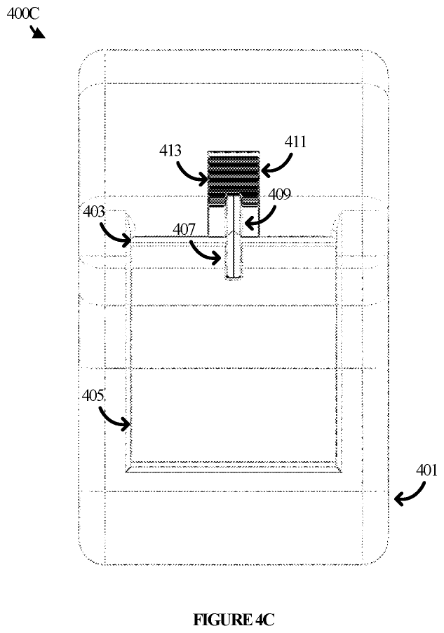

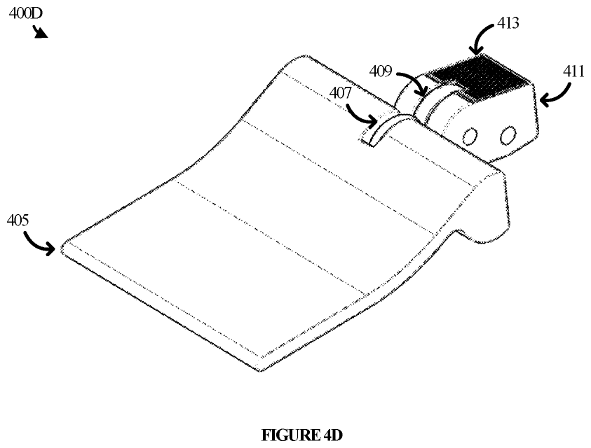

Referring to FIGS. 4A-4D, a thermal paper printer with a built-in creasing mechanism represents an implementation where the creasing functionality is integrated directly into the printer during manufacturing rather than added as an aftermarket attachment. FIG. 4A illustrates isometric view 400A of the thermal paper printer, FIG. 4B illustrates side view 400B, FIG. 4C illustrates top view 400C, and FIG. 4D illustrates isometric view 400D showing printer door 405 with the integrated creasing mechanism. The thermal paper printer includes printer body 401 that houses the printing components and incorporates a creasing mechanism positioned along the paper path.

As shown in FIG. 4A, printer body 401 includes paper exit path 403 through which printed thermal paper exits the printer. Printer body 401 houses a print head configured to print on paper. The print head applies heat to chemically treated thermal paper to create text and graphics as the paper feeds through the printing mechanism. Paper exit path 403 is positioned downstream from the print head such that paper passes through the creasing mechanism after exiting the print head and before exiting printer body 401.

Printer body 401 includes printer door 405 configured as a hinged lid portion that opens for paper loading and maintenance operations. Printer door 405 provides access to an internal paper roll compartment and allows users to replace thermal paper rolls as needed. When printer door 405 closes, the creasing mechanism components align to process paper as it exits the printer.

With continued reference to FIG. 4A, the built-in creasing mechanism includes ridged roller 407 and grooved roller 409 positioned on opposing sides of paper exit path 403. Ridged roller 407 has a ridge extending circumferentially around ridged roller 407. Grooved roller 409 has a groove extending circumferentially around grooved roller 409. Ridged roller 407 and grooved roller 409 are positioned to engage with one another such that paper passing between them receives a crease from the engagement between the ridge and the groove. The crease counteracts the natural curvature of paper stored on cylindrical rolls, allowing the paper to lie flat without manual manipulation.

Ridged roller 407 couples to printer door 405, while grooved roller 409 couples to a stationary base portion of printer body 401. This configuration maintains the ability to open the printer for paper loading while providing integrated creasing functionality. When printer door 405 closes, ridged roller 407 aligns with grooved roller 409 to form the creasing mechanism along paper exit path 403. The printer body includes the hinged lid portion (printer door 405) configured to open for paper loading, with the first roller (grooved roller 409) coupled to the stationary base portion and the second roller (ridged roller 407) coupled to the hinged lid portion.

As shown in FIGS. 4A and 4C, hinged housing 411 supports grooved roller 409 and is positioned adjacent to paper exit path 403. Hinged housing 411 includes grip surface 413 on an upper portion of hinged housing 411. Grip surface 413 is configured to allow manual displacement of grooved roller 409 away from ridged roller 407. A user presses on grip surface 413 to move hinged housing 411 and displace grooved roller 409, enabling paper threading operations when loading a new paper roll or enabling retrieval of paper that is not creased when uncreased output is desired.

Hinged housing 411 may be spring-loaded to maintain pressure between grooved roller 409 and ridged roller 407 when printer door 405 is closed. The spring-loaded configuration maintains consistent creasing pressure regardless of paper thickness variations or mechanical wear over time. When a user releases grip surface 413 after pressing, the spring automatically returns hinged housing 411 to its default position where grooved roller 409 engages with ridged roller 407 for creasing.

In some built-in implementations, hinged housing 411 may be omitted where roller placement can be controlled by the printer manufacturer. Because the manufacturer controls the positioning and alignment of components during printer design and assembly, the rollers may be positioned at fixed locations that provide the appropriate spacing and engagement for creasing without requiring user-adjustable housings. In such implementations, grooved roller 409 mounts directly to the stationary base portion of printer body 401 at a predetermined position, and ridged roller 407 mounts directly to printer door 405 at a corresponding position that ensures proper engagement when printer door 405 closes.

The groove of grooved roller 409 may include a V-shaped groove with angled sides that create a defined crease line. The ridge of ridged roller 407 may include a V-shaped ridge configured to mate with the V-shaped groove of grooved roller 409. In some implementations, the V-shaped ridge has a groove angle that is more acute than a groove angle of the V-shaped groove of grooved roller 409, which facilitates proper engagement and crease formation. Alternative groove and ridge configurations include U-shaped profiles, rounded profiles, or mismatched profiles as described previously with respect to paper creasing device 101 and the two-piece paper creasing system.

As shown in FIG. 4D, isometric view 400D depicts printer door 405 with the integrated creasing mechanism, with printer body 401 omitted from the view. Printer door 405 includes ridged roller 407, while hinged housing 411 includes grooved roller 409 and grip surface 413. This view illustrates the spatial relationship between the creasing components when printer door 405 is separated from printer body 401.

Paper printed by the print head passes between grooved roller 409 and ridged roller 407 after exiting the print head and before exiting printer body 401. The engagement between the ridge of ridged roller 407 and the groove of grooved roller 409 creates a crease in the paper that counteracts the natural curvature resulting from storage on cylindrical rolls. The rollers rotate freely as paper feeds through the mechanism, utilizing the existing paper feed force from the printer without requiring additional power or motorized components.

The embodiment of the thermal paper printer with built-in creasing mechanism illustrated in FIGS. 4A-4D represents one example implementation, and other implementations exist without deviating from the scope of the disclosure. Other implementations may include printers with additional, fewer, or different elements in different configurations. For example, some implementations may position ridged roller 407 on the stationary base portion and grooved roller 409 on printer door 405, may include set screws rather than spring-loaded housings for tension adjustment, may omit hinged housing 411 entirely in favor of fixed roller mounting controlled by the manufacturer, or may include or omit bearing components depending on operational requirements. The components themselves may differ across implementations, including variations in adjustability, axle configurations, bearing arrangements, groove and ridge geometries, and the presence or absence of grip surfaces or hinged housings.

As will be appreciated by one skilled in the art, aspects of the present technology include mechanical systems, devices, and methods for creasing paper. While the technology is primarily described in the context of thermal printers, the fundamental mechanical principles and operational advantages of counter-creasing paper as it transitions from rolled storage to flat usage have broad applicability across diverse paper handling systems. Such systems may include, but are not limited to, standard desktop inkjet printers utilizing rolled paper media, large-format plotters and technical drawing systems, automated label printing and application systems, lottery and event ticket printing systems, medical chart recording devices, financial transaction receipt systems, mobile printing solutions, and any other paper-handling system where media is supplied from a cylindrical roll and subsequently requires a flattened state for optimal functionality. Accordingly, aspects of the present technology take the form of standalone mechanical devices, printer-integrated mechanisms, multi-component systems, or combinations thereof that may all generally be referred to herein as a “device,” “mechanism,” or “system.”

The included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Features described above combine in various ways to form multiple embodiments. As a result, the invention is not limited to the specific embodiments described above, but only by the claims and their equivalents.

What is claimed is:

1. A paper creasing device, comprising:
a base configured to attach to a printer adjacent to a paper exit path;
a first roller mounted to the base, the first roller having a groove extending circumferentially around the first roller;
a second roller mounted to the base in alignment with the first roller, the second roller having a ridge extending circumferentially around the second roller and configured to engage with the groove of the first roller; and
a housing supporting at least one of the first roller and the second roller, wherein paper passing between the first roller and the second roller receives a crease from engagement between the ridge and the groove.

2. The paper creasing device of claim 1, wherein the housing is hinged to the base to allow adjustment of spacing between the first roller and the second roller.

3. The paper creasing device of claim 2, further comprising a set screw configured to adjust tension between the first roller and the second roller.

4. The paper creasing device of claim 2, further comprising a spring configured to maintain pressure between the first roller and the second roller.

5. The paper creasing device of claim 1, wherein the base includes a slot configured to receive paper from the printer, the slot having a width sufficient to accommodate thermal paper.

6. The paper creasing device of claim 1, wherein the groove of the first roller comprises a V-shaped groove.

7. The paper creasing device of claim 6, wherein the ridge of the second roller comprises a V-shaped ridge having a groove angle that is more acute than a groove angle of the V-shaped groove of the first roller.

8. The paper creasing device of claim 1, wherein the base is configured to attach to the printer via an adhesive mounting system.

9. The paper creasing device of claim 1, wherein the housing includes a grip surface configured to allow manual displacement of the second roller away from the first roller.

10. A paper creasing system, comprising:
a first component configured to attach to a first surface of a printer, the first component including a first roller having a groove extending circumferentially around the first roller; and
a second component configured to attach to a second surface of the printer, the second component including a second roller having a ridge extending circumferentially around the second roller,
wherein the first component and the second component are configured to be positioned on opposite sides of a paper exit path of the printer such that paper exiting the printer passes between the first roller and the second roller and receives a crease from engagement between the ridge and the groove.

11. The paper creasing system of claim 10, wherein the first surface comprises a stationary base portion of the printer and the second surface comprises a hinged lid portion of the printer.

12. The paper creasing system of claim 11, wherein the second component includes a spring-loaded housing configured to maintain pressure between the first roller and the second roller when the hinged lid portion is closed.

13. The paper creasing system of claim 12, wherein the second component includes a grip surface configured to allow manual displacement of the second roller away from the first roller for paper threading.

14. The paper creasing system of claim 10, wherein the first component and the second component are each configured to attach to the printer via an adhesive mounting system.

15. The paper creasing system of claim 10, wherein the groove of the first roller comprises a V-shaped groove and the ridge of the second roller comprises a V-shaped ridge configured to mate with the V-shaped groove.

16. A printer, comprising:
a printer body having a paper exit path;
a print head configured to print on paper; and
a creasing mechanism positioned along the paper exit path, the creasing mechanism including:
a first roller having a groove extending circumferentially around the first roller, and
a second roller having a ridge extending circumferentially around the second roller and positioned to engage with the groove of the first roller,
wherein paper printed by the print head passes between the first roller and the second roller and receives a crease from engagement between the ridge and the groove.

17. The printer of claim 16, wherein the printer body includes a hinged lid portion configured to open for paper loading and a stationary base portion, and wherein the first roller is coupled to the stationary base portion and the second roller is coupled to the hinged lid portion of the printer body.

18. The printer of claim 17, wherein the creasing mechanism further includes a spring-loaded housing supporting the first roller and configured to maintain pressure between the first roller and the second roller when the hinged lid portion is closed.

19. The printer of claim 16, wherein the groove of the first roller comprises a V-shaped groove and the ridge of the second roller comprises a V-shaped ridge configured to mate with the V-shaped groove.

20. The printer of claim 16, wherein the first roller and the second roller are positioned such that paper passes between the first roller and the second roller after exiting a print head of the printer and before exiting the printer body.
